(19) United States
(12) Patent Application Publication
(10) Pub. No.: US 2026/0259445 A1
(43) Pub. Date: Sep. 3, 2026

(54) LIQUID CRYSTAL ELEMENT, PRODUCTION METHOD OF LIQUID CRYSTAL ELEMENT

(71) Applicant: STANLEY ELECTRIC CO., LTD., Meguro-ku, Tokyo (JP)

(72) Inventors: Yasuo TOKO, Tokyo (JP); Satomi SUZUKI, Tokyo (JP)

(73) Assignee: STANLEY ELECTRIC CO., LTD., Meguro-ku, Tokyo (JP)

(21) Appl. No.: 18/875,543

(22) PCT Filed: May 16, 2023
(86) PCT No.: PCT/JP2023/018286

§ 371 Date: Dec. 16, 2024

(30) Foreign Application Priority Data
Jun. 16, 2022 (JP) 2022-097406

(51) Int. Cl. G02F 1/1333; G02F 1/1337

(52) U.S. Cl. CPC G02F 1/133345; G02F 1/133711; G02F 1/133788

(57) ABSTRACT

The production method includes: forming a LC layer by disposing a LC material between a first and a second substrate; by applying light irradiation to the LC layer from a direction oblique to an other surface facing at least the one surface of the first or second substrate, forming a first polymer layer disposed in a direction inclined to the one surface of the first substrate on a surface of the first insulating film facing the LC layer, and forming a second polymer layer disposed in a direction inclined to the one surface of the second substrate on a surface of the second insulating film facing the LC layer; where the LC material contains a photopolymerizable monomer and is a trans body having a double bond in the center.

### TECHNICAL FIELD

The present disclosure relates to a liquid crystal element, and a production method of the liquid crystal element.

### BACKGROUND ART

Japanese Unexamined Patent Application Publication No. 2019-128383 (Patent Document 1) describes a liquid crystal display apparatus having a pair of substrates, a liquid crystal layer disposed between the pair of substrates, alignment films disposed on the liquid crystal layer side surface of at least one of the pair of substrates, and a polymer layer disposed between the liquid crystal layer and each alignment film. In this liquid crystal display apparatus, the liquid crystal layer contains a liquid crystal compound aligned in a predetermined direction when no voltage is applied, each alignment film contains a first polymer having at least one of a polyamic acid structure and a polyimide structure in its main chain, the first polymer has a functional group that functions as a polymerization initiator, and each polymer layer contains a second polymer obtained by polymerizing at least one monomer having a chalcone group.

### PRIOR ART DOCUMENT

### Patent Document

[Patent Document 1] Japanese Unexamined Patent Application Publication No.2019-128383

### SUMMARY OF THE INVENTION

### Technical Problem

In a specific aspect, it is an object of the present disclosure to provide a production method of a liquid crystal element that does not require a special alignment film and is easy to produce. In a specific aspect, it is another object of the present disclosure to provide a liquid crystal element obtained by the above-described production method.

### Solution to the Problem

(1) A production method of a liquid crystal element according to one aspect of the present disclosure is a production method of a liquid crystal element including: (a) forming a first insulating film on one surface side of a first substrate; (b) forming a second insulating film on one surface side of a second substrate; (c) forming a liquid crystal layer between the one surface of the first substrate and the one surface of the second substrate; and (d) by applying light irradiation to the liquid crystal layer from a direction oblique to an other surface facing at least one of the one surface of the first substrate or the second substrate, forming a first polymer layer having a polymer disposed in a direction inclined relative to the one surface of the first substrate on a surface of the first insulating film facing the liquid crystal layer, and forming a second polymer layer having a polymer disposed in a direction inclined relative to the one surface of the second substrate on a surface of the second insulating film facing the liquid crystal layer, where the liquid crystal material used to form the liquid crystal layer in the above-described (c) contains a monomer that is photopolymerizable and is a trans body having a double bond in the center.

(2) A liquid crystal element according to one aspect of the present disclosure is a liquid crystal element including: (a) a first substrate having a first insulating film on one surface side; (b) a second substrate having a second insulating film on one surface side, the second substrate disposed with a gap provided between the first substrate and the second substrate, with the first insulating film and the second insulating film facing each other; (c) a liquid crystal layer disposed in the gap between the first substrate and the second substrate; (d) a first polymer layer having a polymer disposed in a direction inclined relative to the one surface of the first substrate on a surface of the first insulating film facing the liquid crystal layer, and (e) a second polymer layer having a polymer disposed in a direction inclined relative to the one surface of the second substrate on a surface of the second insulating film facing the liquid crystal layer.

According to the above configurations, a production method of a liquid crystal element that does not require a special alignment film and is easy to produce is provided. Further, a liquid crystal element obtained by the production method is provided.

### BRIEF DESCRIPTION OF THE DRAWINGS

FIG. 1(A) is a schematic cross-sectional view for explaining the configuration of a liquid crystal element according to a first embodiment.

FIG. 1(B) is a schematic diagram showing polymers included in the first polymer layer or the second polymer layer.

FIG. 2(A) to FIG. 2(F) are diagrams for explaining the production method of the liquid crystal element according to the first embodiment.

FIG. 3(A) to FIG. 3(C) are diagrams for explaining the production method of the liquid crystal element according to the first embodiment.

FIG. 4(A) and FIG. 4(B) are diagrams for explaining a modified example of the process of applying light irradiation to the liquid crystal layer.

FIG. 5(A) is a schematic cross-sectional view for explaining the configuration of a liquid crystal element according to a second embodiment.

FIG. 5(B) is a schematic cross-sectional view for explaining the configuration of a liquid crystal element according to a third embodiment.

FIG. 6 shows a relationship between irradiation angle and pretilt angle during light irradiation in the liquid crystal element of Example 1, which was fabricated using a monomer containing a chalcone group.

FIG. 7 shows a relationship between irradiation angle and pretilt angle during light irradiation in the liquid crystal element of Example 2.

### MODE FOR CARRYING OUT THE INVENTION

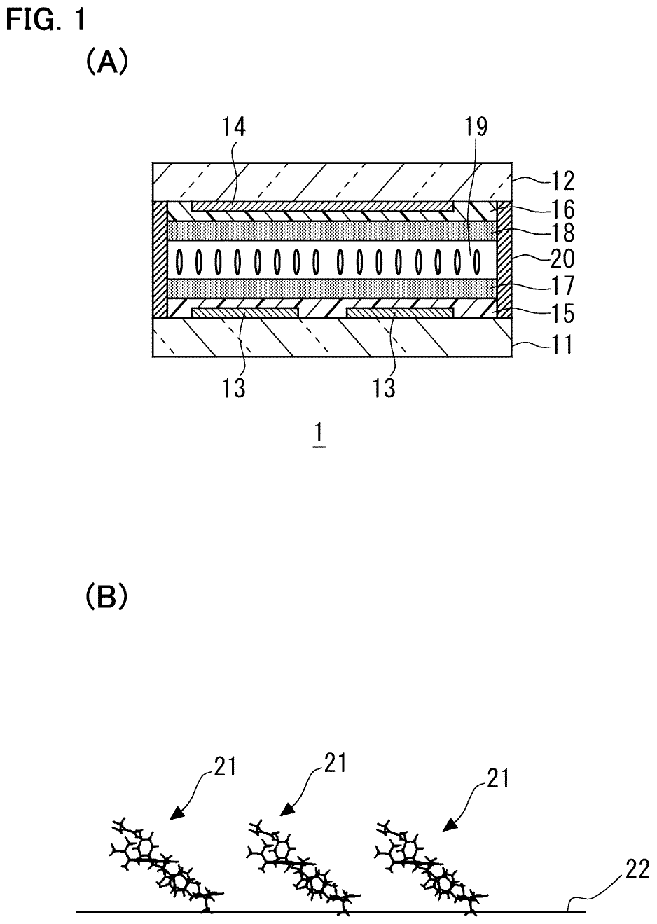

FIG. 1(A) is a schematic cross-sectional view for explaining the configuration of a liquid crystal element according to a first embodiment. The liquid crystal element 1 shown in the figure is configured to include a first substrate 11 and a second substrate 12 arranged to face each other, a plurality of pixel electrodes 13, a counter electrode 14, a first insulating film 15, a second insulating film 16, a first polymer layer 17, a second polymer layer 18, a liquid crystal layer 19, and a sealing material 20.

The first substrate 11 and the second substrate 12 are each a transparent substrate having a rectangular shape in a plane view, and are arranged with one surface facing each other, for example. The first substrate 11 and the second substrate 12 can be a glass substrate or a plastic substrate, for example. Spherical spacers (not shown) made of, for example, a resin film are dispersed between the first substrate 11 and the second substrate 12, and these spherical spacers maintain a gap between the substrates at the desired size (for example, about a few μm).

Here, instead of spherical spacers, columnar bodies made of resin or the like may be provided on the first substrate 11 side or the second substrate 12 side and used as spacers. Further, although not shown, the liquid crystal element 1 may have a polarizer or polarizing element disposed on the outer side of each of the first substrate 11 and the second substrate 12 (the side not facing the liquid crystal layer 19), and an optical compensator such as a phase difference plate can be disposed between each polarizer, etc. and the first substrate 11 or the second substrate 12.

The plurality of pixel electrodes 13 are provided on one surface side of the first substrate 11. These pixel electrodes 13 are formed by appropriately patterning a transparent conductive film such as indium tin oxide (ITO). In the present embodiment, a pixel portion is formed in the area where each pixel electrode 13 faces the counter electrode 14.

The counter electrode 14 is provided on one surface side of the second substrate 12. This counter electrode 14 is provided integrally with and faces each pixel electrode 13 of the first substrate 11. The counter electrode 14 is formed by appropriately patterning a transparent conductive film such as indium tin oxide (ITO).

The first insulating film 15 is provided on one surface side of the first substrate 11, covering each pixel electrode 13. The second insulating film 16 is provided on one surface side of the second substrate 12, covering the counter electrode 14. The first insulating film 15 and the second insulating film 16 are arranged facing each other with a gap provided therebetween. The first insulating film 15 and the second insulating film 16 are preferably inorganic insulating films formed using silica or titania, for example, and a titano-siloxane based inorganic insulating film can be used. No alignment treatment such as rubbing treatment is performed on either the first insulating film 15 or the second insulating film 16.

The first polymer layer 17 is disposed so as to be in contact with the liquid crystal layer 19 on the surface of the first insulating film 15 facing the liquid crystal layer 19. Further, the second polymer layer 18 is disposed so as to be in contact with the liquid crystal layer 19 on the surface of the second insulating film 16 facing the liquid crystal layer 19. The first polymer layer 17 has a plurality of polymers disposed in a direction inclined relative to one surface of the first substrate 11. Similarly, the second polymer layer 18 has a plurality of polymers disposed in a direction inclined relative to one surface of the second substrate 12.

The liquid crystal layer 19 is provided in the gap between the first substrate 11 and the second substrate 12. The liquid crystal layer 19 is composed of a nematic liquid crystal material having fluidity, for example. The liquid crystal layer 19 is composed of a liquid crystal material having negative dielectric anisotropy, for example. The thickness of the liquid crystal layer 19 can be set to about 4 μm, for example. The liquid crystal layer 19 is aligned by the alignment regulating forces exerted by the first polymer layer 17 and the second polymer layer 18, and is uniformly aligned with a pretilt angle of, for example, about 85° to 89.9° when no voltage is applied (including when a voltage below a threshold is applied).

The sealing material 20 is provided between the first substrate 11 and the second substrate 12 so as to surround the liquid crystal layer 19, and seals the liquid crystal layer 19. As shown in the figure, in the present embodiment, the sealing material 20 is provided so as to surround the outside of the area in which the first insulating film 15, the second insulating film 16, the first polymer layer 17, and the second polymer layer 18 are provided.

FIG. 1(B) is a schematic diagram showing polymers included in the first polymer layer or the second polymer layer. Each polymer 21 is disposed at an angle on one surface 22 of each of the first insulating film 15 and the second insulating film 16. In other words, each polymer 21 is disposed in a direction inclined relative to one surface of the first substrate 11 and the second substrate 12. Each polymer 21 in the first embodiment is formed by polymerizing a trans body having a double bond in the center of the molecule by light irradiation (ultraviolet light irradiation in the present embodiment), and has two or more polymerization sites. Further, it is also preferable that each polymer 21 is formed by polymerizing a monomer containing a chalcone group.

In the example shown, each polymer 21 is uniformly disposed toward the upper left in the figure. “Uniformly” here does not mean that each of the polymers 21 faces in strictly the same direction, but rather that they face in roughly the same direction. These polymers 21 exert an alignment regulating force on the liquid crystal layer 19, allowing the liquid crystal molecules in the liquid crystal layer 19 to be uniformly aligned. Here, note that although only polymers 21 are shown here, monomers may remain on one surface 22 of each of the first insulating film 15 and the second insulating film 16.

As an example, mechanism by which the alignment regulating force manifests when a monomer containing a chalcone group is used is presumed to be as follows. A molecule of a monomer containing a chalcone group (RM molecule) has three reactive sites, and the inner olefin (the double bond in the center of the molecule) is less susceptible to photopolymerization than the reactive sites at either end. The double bond in the center of the molecule can be cis-trans body, but trans body is predominant. In the case of trans body, it is considered that the double bond in the center of the RM molecule causes the molecular alignment to be slightly tilted. Before applying light irradiation, the liquid crystal molecules in the liquid crystal layer 19 are almost completely aligned vertically, and the RM molecules also face in the same direction, however, since they are trans body, each molecule is slightly tilted. When light irradiation is applied to the liquid crystal layer 19 from an oblique direction, the inner olefin in the part that is easily exposed to ultraviolet light polymerizes, and the remaining RM molecules which are trans body are tilted, which is thought to have the effect of slightly aligning the liquid crystal molecules.

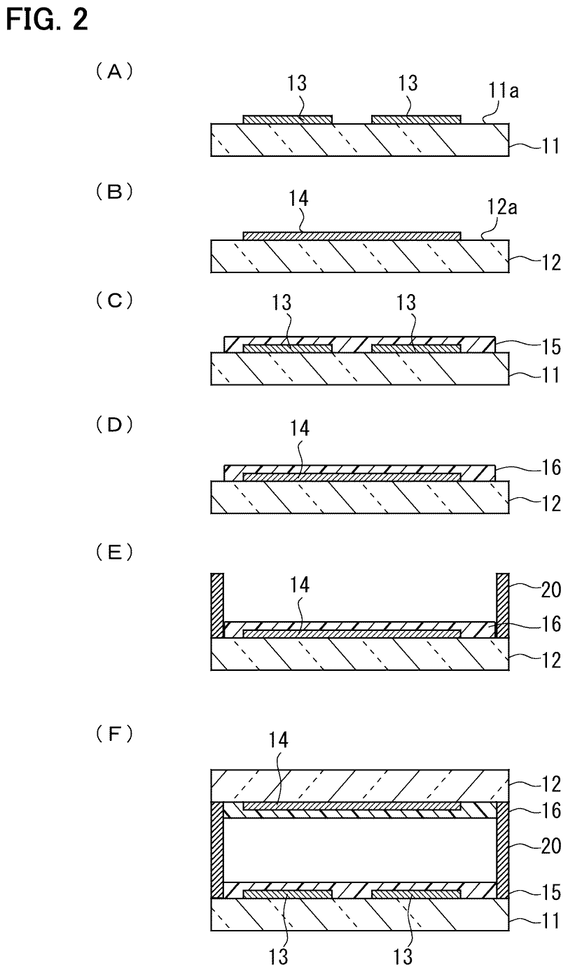

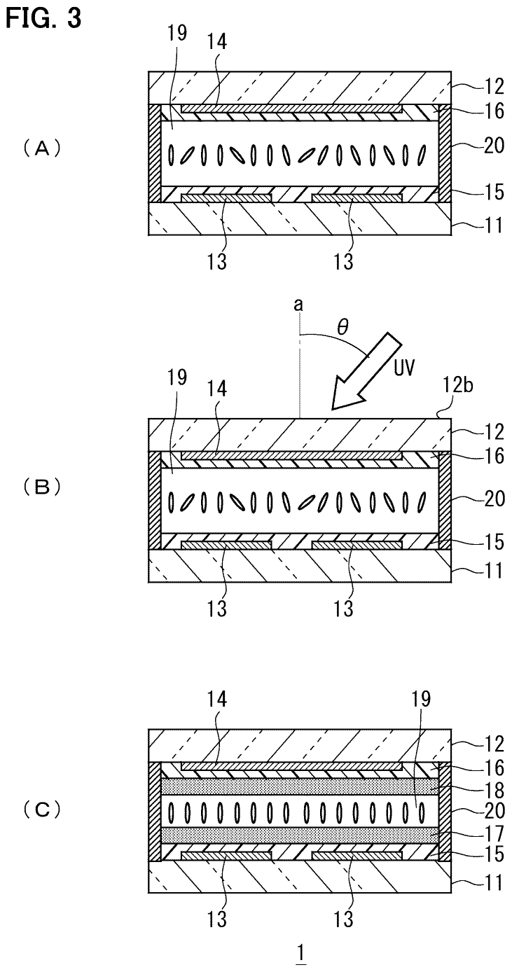

FIG. 2(A) to FIG. 2(F) and FIG. 3(A) to FIG. 3(C) are diagrams for explaining the production method of the liquid crystal element according to the first embodiment. Here, note that the order of the steps can be changed or they can be performed in parallel as long as no contradictions or inconsistencies arise, and other steps not shown or described (such as a cleaning step) can be added as appropriate.

First, a first substrate 11 having each pixel electrode 13 on one surface 11a is prepared (FIG. 2(A)), and a second substrate 12 having a counter electrode 14 on one surface 12a is prepared (FIG. 2(B)). As described above, each pixel electrode 13 and counter electrode 14 are obtained by patterning an ITO film formed on one surface of each of the first substrate 11 and the second substrate 12 by photolithography or other techniques, for example.

Next, a first insulating film 15 is formed on one surface 11a of the first substrate 11 so as to cover each pixel electrode 13 (FIG. 2(C)). Similarly, a second insulating film 16 is formed on one surface 12a of the second substrate 12 so as to cover the counter electrode 14 (FIG. 2(D)).

The first insulating film 15 and the second insulating film 16 are preferably inorganic insulating films formed using silica or titania, for example, and a titanosiloxane-based inorganic insulating film can be used, for example. There is no particular limitation on the forming method of the first insulating film 15 and the second insulating film 16, and sputtering method, vapor deposition method, CVD method, printing method, etc. can be used as appropriate. In particular, in terms of simplifying the process, it is preferable to form the first insulating film 15 and the second insulating film 16 using an insulating film to which a printing method can be applied, such as a titanosiloxane-based inorganic insulating film.

Next, a sealing material 20 is applied to one surface side of the first substrate 11 or the second substrate 12 (FIG. 2(E)). In the illustrated example, the sealing material 20 is applied to the one surface 12a of the second substrate 12, but the sealing material 20 may also be applied to the one surface 11a of the first substrate 11. In the present embodiment, a sealing material 20 made of a photocurable resin is used. Further, spherical spacers for gap control are sprayed on one surface side of the substrate (first substrate 11 in the present embodiment) on the side to which the sealing material 20 is not applied.

Next, the first substrate 11 and the second substrate 12 are bonded together with the first insulating film 15 and the second insulating film 16 facing each other (FIG. 2(F)). A gap is provided between the first substrate 11 and the second substrate 12 by spherical spacers.

Next, a liquid crystal material is injected by vacuum injection method to the gap between the first substrate 11 and the second substrate 12 through an injection port (a portion of the sealing material 20 which has been opened) not shown, thereby forming a liquid crystal layer 19 (FIG. 3(A)). In the present embodiment, a liquid crystal material containing a monomer that can be polymerized by light (particularly ultraviolet light), the monomer being a trans body having a double bond in the center, is used. The monomer contained in the liquid crystal material is preferably a monomer that has two or more polymerization sites, and is also preferably a monomer that contains a chalcone group.

Here, ODF (One Drop Fill) method may be used when injecting the liquid crystal material. In this case, after forming the sealing material 20 and before bonding the first substrate 11 and the second substrate 12 together, the liquid crystal 1 ; dropped (placed) within the area surrounded by the sealing material 20, and then the first substrate 11 and the second substrate 12 are bonded together.

Next, light irradiation is applied to the liquid crystal layer 19 through the first substrate 11 or the second substrate 12 from a direction oblique relative to the other surface which faces one surface of the first substrate 11 or second substrate 12 (FIG. 3(B)). In this process, it is preferable from production viewpoint to perform the process without applying a voltage to the liquid crystal layer 19. Here, this does not negate the application of voltage to the liquid crystal layer 19 during light irradiation. In a case where a voltage is applied, by applying light irradiation from an oblique direction as described above without applying a voltage to the liquid crystal layer 19 for a certain period of time (e.g., 30 seconds to 2 minutes) from the initiation of light irradiation, and then applying a voltage to the liquid crystal layer 19, it is considered that the pretilt angle can be actively controlled by the magnitude of the voltage. There is no particular limitation on the light irradiation direction when applying a voltage, and it may continue to be an oblique direction or may be another direction (e.g., the front direction).

Here, in the present embodiment, since a photocurable material (such as resin) is used as the sealing material 20, the sealing material 20 can be cured simultaneously in the process shown in FIG. 3(B). Therefore, there is no need to add new processes for forming the first polymer layer 15 and the second polymer layer 16 to the conventional production process, and the production method can be simplified. Here, note that although a case where a photocurable resin is used as the sealing material has been described here, a thermosetting resin may also be used. A photocurable resin is preferably used as an end seal material (injection port sealing material) for closing the injection port when performing vacuum injection, and the end seal material can be cured simultaneously during the process shown in FIG. 3(B). Therefore, there is no need to add new processes for forming the first polymer layer 15 and the second polymer layer 16 to the conventional production process, and the production method can be simplified.

In the present embodiment, ultraviolet light is irradiated from a direction oblique to the other surface 12b which faces the one surface 12a of the second substrate 12. For example, if normal line “a” of the second substrate 12 to the other surface 11 is taken as a reference, ultraviolet light UV is irradiated from a direction oblique to the normal line “a” at an angle θ. This angle θ can be set appropriately, for example between 30° and 60°. Here, light irradiation may be applied from a direction oblique relative to the other surface of the first substrate 11, or light irradiation may be applied from a direction oblique to each of the other surfaces of both the other surface side of the first substrate 11 and the other surface side of the second substrate.

The monomer contained in the liquid crystal layer 19 is polymerized by the light irradiation described above. As a result, a first polymer layer 15 is formed on the first substrate 11 side, and a second polymer layer 16 is formed on the second substrate 12 side (FIG. 3(C)). The first polymer layer 15 and the second polymer layer 16 each have polymer or monomer disposed in a direction inclined relative to each of the one surface of the first substrate 11 and the second substrate, as shown in FIG. 1B described above. An alignment regulating force is provided to the liquid crystal layer 19 by the first polymer layer 15 and the second polymer layer 16, so that the liquid crystal layer 19 is uniformly aligned (FIG. 3(C)). With the above, the liquid crystal element 1 is completed.

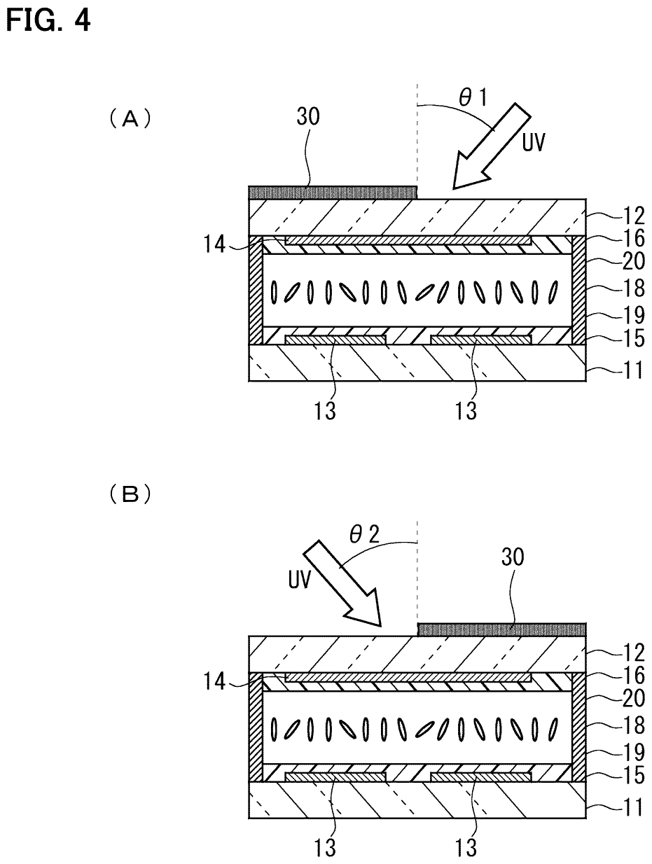

FIG. 4(A) and FIG. 4(B) are diagrams for explaining a modified example of the process of applying light irradiation to the liquid crystal layer. In this process, as shown in FIG. 4(A), a mask 30 that partially shields the left side region of the liquid crystal layer 19 in the figure is disposed on the other surface side of the second substrate 12, and light irradiation is applied via the mask 30. Then, as shown in FIG. 4(B), the position of the mask 30 is changed so as to partially shield the right side region of the liquid crystal layer 19 in the figure, and light irradiation is applied via the mask 30.

In the illustrated example, in the process shown in FIG. 4(A), light irradiation is applied from a direction tilted at an angle θ1 clockwise from the normal of the second substrate 12, and in the process shown in FIG. 4(B), light irradiation is applied from a direction tilted at an angle θ2 counterclockwise from the normal of the second substrate 12. Here, the angles θ1 and θ2 are merely examples, and the angles θ1 and θ2 may be set so that they are different angles in the same direction (clockwise or counterclockwise). For example, light irradiation direction is set clockwise from the direction normal to the second substrate 12 in each process, and the angles can be set as θ1=30° and θ2=45°. In this way, the pretilt angles of the liquid crystal layer 19 can be set to different magnitudes and directions corresponding to the regions with different light irradiation directions. Further, the number of times that the position of the mask 30 is changed is not limited to two times as described above, and more times may be set.

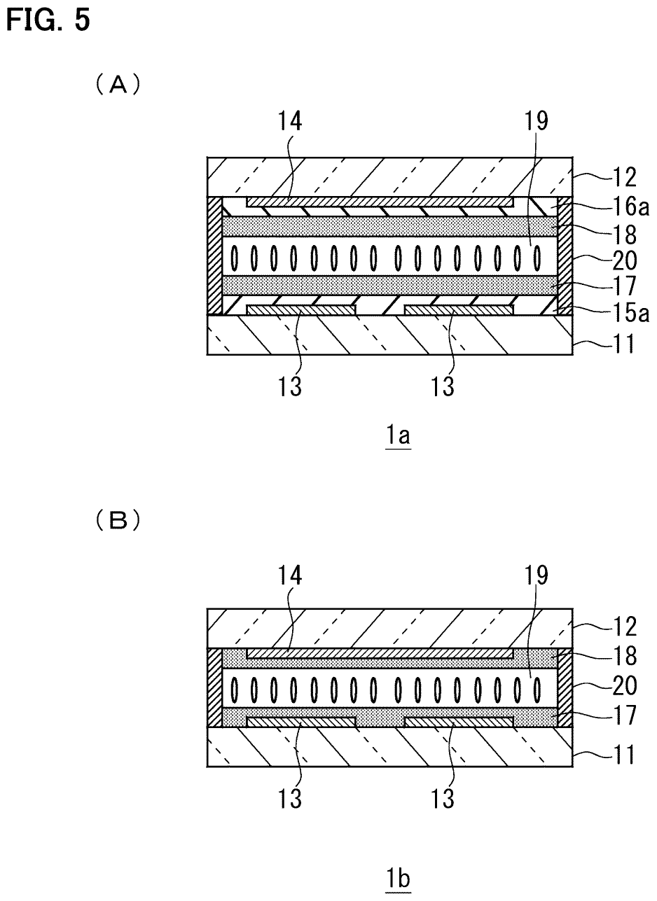

FIG. 5(A) is a schematic cross-sectional view for explaining the configuration of a liquid crystal element according to a second embodiment. The liquid crystal element la of the second embodiment shown in FIG. 5(A) is different from the liquid crystal element 1 of the first embodiment described above in that the first insulating film 15 and the second insulating film 16 are changed to a first insulating film 15a and a second insulating film 16a, respectively, which are made of vertical alignment films, but the other configuration is the same. The first insulating film 15a and the second insulating film 16a are each made of a vertical alignment film whose main chain is inorganic and has side chains. Further, no alignment process such as rubbing treatment is performed on the first insulating film 15a and the second insulating film 16a. And, the first polymer layer 17 is disposed between the first insulating film 15a and the liquid crystal layer 19, and the second polymer layer 18 is disposed between the second insulating film 16a and the liquid crystal layer 19. Such liquid crystal element la of the second embodiment described above can also obtain the same effect as the liquid crystal element 1 of the first embodiment described above.

FIG. 5(B) is a schematic cross-sectional view for explaining the configuration of a liquid crystal element according to a third embodiment. The liquid crystal element 1b of the third embodiment shown in FIG. 5(B) differs from the liquid crystal element 1 of the first embodiment described above in that the first insulating film 15 and the second insulating film 16 are omitted, but the other configuration is the same. In this liquid crystal element 1b, the first polymer layer 17 is disposed between the first substrate 11 and each pixel electrode 13 and the liquid crystal layer 19, and the second polymer layer 18 is disposed between the second substrate 12 and the counter electrode 14 and the liquid crystal layer 19. The liquid crystal element 1a of the third embodiment can also obtain the same effect as the liquid crystal element 1 of the first embodiment described above.

### EXAMPLE 1

A liquid crystal element having the configuration of the liquid crystal element 1 according to the first embodiment was fabricated. A glass substrate was used as the first substrate 11 and the second substrate 12, and a titanosiloxane-based inorganic insulating film was used as the first insulating film 15 and the second insulating film 16. No alignment treatment such as rubbing treatment was performed on the first insulating film 15 and the second insulating film 16. The thickness of the liquid crystal layer 19 was set to about 4 μm. A nematic liquid crystal material with negative dielectric anisotropy was used as the liquid crystal material. A monomer containing a chalcone group or a monomer not containing a chalcone group was added to the liquid crystal material at 0.1 wt%, 0.2 wt%, 0.5 wt%, or 1.0 wt% as a monomer for forming the first polymer layer 17 and the second polymer layer 18. Here, the amount of addition can be adjusted, for example, from 0.1 wt% to 5 wt%. The monomer containing a chalcone group is characterized by being a trans body with a double bond in the center of the molecule and having two or more polymerization sites. In the light irradiation process for the liquid crystal layer 19, ultraviolet light was irradiated from a direction forming an angle of 45° relative to the second substrate 12 (refer to FIG. 3B). The amount of ultraviolet light irradiation was 20 J/cm² (=28 mW/cm²×12 min). Here, note that a self-alignment agent may be added to the liquid crystal material at approximately 0.1 wt% to 10 wt%.

When comparing the appearance of a liquid crystal element made using a monomer containing a chalcone group with that made using a monomer not containing a chalcone group, the former tended to have better uniformity of alignment of the liquid crystal layer 19.

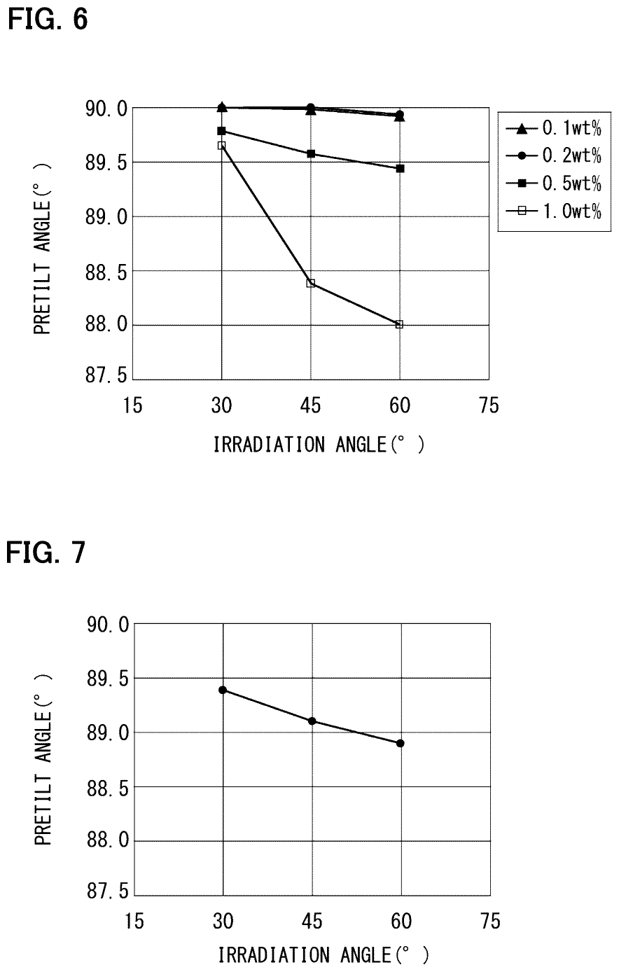

FIG. 6 shows a relationship between irradiation angle and pretilt angle during light irradiation in the liquid crystal element of Example 1, which was fabricated using a monomer containing a chalcone group. Four patterns were set for the amount of monomer added: 0.1 wt%, 0.2 wt%, 0.5 wt%, and 1.0 wt%. Three patterns were set for the irradiation angle θ (refer to FIG. 3(B)):30°, 45°, and 60°. When the amount of monomer added was 0.1 wt% and 0.2 wt%, the pretilt angle was 89.9° to 90°, almost independent of the irradiation angle during light irradiation, and even when the irradiation angle was 60°, the pretilt angle was about 89.9°. When it is desired to obtain a liquid crystal layer 19 with a vertical alignment with a pretilt angle of 90° or a nearly vertical alignment with a pretilt angle of about 89.9°, it is considered to be beneficial to secure a large margin for the error of the irradiation angle during light irradiation.

On the other hand, when the amount of monomer added was 0.5 wt % and 1.0 wt %, it was found that the dependency of the pretilt angle on the irradiation angle during light irradiation was more clearly evident. Specifically, pretilt angles were obtained in the range of 88.0° to 89.7°. Further, there was a tendency for the pretilt angle to decrease as the irradiation angle increased. If one wishes to actively impart a pretilt angle to the liquid crystal layer 19, it is considered to be beneficial since the pretilt angle can be controlled by the irradiation angle.

### EXAMPLE 2

A liquid crystal element having the configuration of the liquid crystal element 1a according to the second embodiment was fabricated. Glass substrates were used as the first substrate 11 and the second substrate 12, and vertical alignment films having inorganic main chains and side chains were used as the first insulating film 15a and the second insulating film 16a. No alignment treatment such as rubbing treatment was performed on the first insulating film 15a and the second insulating film 16a. The thickness of the liquid crystal layer 19 was set to about 4 μm. A nematic liquid crystal material with negative dielectric anisotropy was used as the liquid crystal material. As a monomer for forming the first polymer layer 17 and the second polymer layer 18, a monomer containing a chalcone group was added to the liquid crystal material at 0.3 wt%. The monomer containing a chalcone group is a trans body having a double bond in the center of the molecule and has two or more polymerization sites. In the light irradiation process for the liquid crystal layer 19, the irradiation angle θ (refer to FIG. 3(B)) was set to three patterns: 30°, 45°, and 60°. The amount of ultraviolet light irradiation was 20 J/cm² (=28 mW/cm²×12 min). Here, note that a self-alignment agent may be added to the liquid crystal material at approximately 0.1 wt% to 10 wt%.

FIG. 7 shows a relationship between irradiation angle and pretilt angle during light irradiation in the liquid crystal element of Example 2. It was found that the pretilt angle is dependent on the irradiation angle during light irradiation. Specifically, the pretilt angle was obtained in the range of 89.4° to 88.9°. Further, it was found that the pretilt angle tended to decrease as the irradiation angle increased.

### EXAMPLE 3

A liquid crystal element was fabricated under the same condition as in Example 1, and light irradiation was applied multiple times using a mask during light irradiation. Specifically, in the light irradiation process (refer to FIG. 4(A) and FIG. 4(B)), light irradiation was applied from a direction tilted 45° clockwise from the normal to the second substrate 12 to the area not shielded by the mask 30, and then the position of the mask 30 was changed, and light irradiation was applied from a direction tilted 30° counterclockwise from the normal to the second substrate 12 to the area not shielded by the position-changed mask 30.

When the pretilt angle of the obtained liquid crystal element was measured, the pretilt angle was 88.4° in the area where the irradiation angle during light irradiation was 45°, and the pretilt angle was also 88.4° in the area where the irradiation angle during light irradiation was 30°. Further, the best viewing direction (the direction in which the pretilt angle is set) of the area where the irradiation angle during light irradiation was 45° and the area where the irradiation angle was 30° was 180° opposite each other. In other words, a multi-domain alignment had been obtained.

According to each of the above-described embodiments and examples, a production method of a liquid crystal element that is easy to produce without requiring a special alignment film is provided. Further provided is a liquid crystal element obtained by the production method.

Here, the present disclosure is not limited to the content of the embodiments described above, and can be implemented with various modifications within the scope of the gist of the present disclosure. For example, the numerical conditions or the like described in the above embodiments, etc. are merely examples, and the present disclosure is not limited to these numerical conditions.

The present disclosure has features as appended below.

### Appendix 1

A production method of a liquid crystal element including:
(a) forming a first insulating film on one surface side of a first substrate;
(b) forming a second insulating film on one surface side of a second substrate;
(c) forming a liquid crystal layer between the one surface of the first substrate and the one surface of the second substrate; and
(d) by applying light irradiation to the liquid crystal layer from a direction oblique to an other surface facing at least one of the one surface of the first substrate or the second substrate, forming a first polymer layer having a polymer disposed in a direction inclined relative to the one surface of the first substrate on a surface of the first insulating film facing the liquid crystal layer, and forming a second polymer layer having a polymer disposed in a direction inclined relative to the one surface of the second substrate on a surface of the second insulating film facing the liquid crystal layer,
where the liquid crystal material used to form the liquid crystal layer in the above-described (c) contains a monomer that is photopolymerizable and is a trans body having a double bond in the center.

### Appendix 2

The production method of a liquid crystal element according to Appendix 1,
where the oblique direction during the light irradiation in the above-described (d) is a direction that forms an angle between 30° and 60° with respect to the other surface of either the first substrate or the second substrate.

### Appendix 3

The production method of a liquid crystal element according to Appendix 1 or 2,
where the monomer is a monomer that can be polymerized by ultraviolet light.

### Appendix 4

The production method of a liquid crystal element according to any one of Appendices 1 to 3,
where the monomer has two or more polymerization sites.

### Appendix 5

The production method of a liquid crystal element according to any one of Appendices 1 to 4,
where the monomer is a monomer that contains a chalcone group.

### Appendix 6

The production method of a liquid crystal element according to any one of Appendices 1 to 5,
where the first insulating film and the second insulating film are inorganic insulating films formed using silica or titania.

### Appendix 7

The production method of a liquid crystal element according to any one of Appendices 1 to 5,
where the first insulating film and the second insulating film are vertical alignment films having an inorganic main chain and side chains, and which have not been subjected to an alignment treatment.

### Appendix 8

The production method of a liquid crystal element according to any one of Appendices 1 to 7,
where the above-described (e) includes disposing a mask on the other surface side of the first substrate or the second substrate to partially block light from the liquid crystal layer and applying the light irradiation through the mask, and applying the light irradiation each time the disposition of the mask is changed.

### Appendix 9

A liquid crystal element including:
a first substrate having a first insulating film on one surface side;
a second substrate having a second insulating film on one surface side, the second substrate disposed with a gap provided between the first substrate and the second substrate, with the first insulating film and the second insulating film facing each other;
a liquid crystal layer disposed in the gap between the first substrate and the second substrate;
a first polymer layer having a polymer disposed in a direction inclined relative to the one surface of the first substrate on a surface of the first insulating film facing the liquid crystal layer, and
a second polymer layer having a polymer disposed in a direction inclined relative to the one surface of the second substrate on a surface of the second insulating film facing the liquid crystal layer.

### Appendix 10

The liquid crystal element according to Appendix 9,
where the first insulating film and the second insulating film are inorganic insulating films formed using silica or titania.

### Appendix 11

The liquid crystal element according to Appendix 9 or 10,
where the liquid crystal layer is uniformly aligned due to the alignment regulating force exerted by the first polymer layer and/or the second polymer layer.

### Appendix 12

The liquid crystal element according to any one of Appendices 9 to 11,
where the polymer of each of the first polymer layer and the second polymer layer is a polymerized monomer having a trans body with a double bond in the center.
11: First substrate
12: Second substrate
13: Pixel electrode
14: Counter electrode
15, 15a: First insulating film
16, 16a: Second insulating film
17: First polymer layer
18: Second polymer layer
19: Liquid crystal layer
20: Sealing material
21: Polymer
30: Mask

1. A production method of a liquid crystal element comprising:
(a) forming a first insulating film on one surface side of a first substrate;
(b) forming a second insulating film on one surface side of a second substrate;
(c) forming a liquid crystal layer between the one surface of the first substrate and the one surface of the second substrate; and
(d) by applying light irradiation to the liquid crystal layer from a direction oblique to an other surface facing at least one of the one surface of the first substrate or the second substrate, forming a first polymer layer having a polymer disposed in a direction inclined relative to the one surface of the first substrate on a surface of the first insulating film facing the liquid crystal layer, and forming a second polymer layer having a polymer disposed in a direction inclined relative to the one surface of the second substrate on a surface of the second insulating film facing the liquid crystal layer,
wherein the liquid crystal material used to form the liquid crystal layer in the above-described (c) contains a monomer that is photopolymerizable and is a trans body having a double bond in the center.

2. The production method of a liquid crystal element according to claim 1,
wherein the oblique direction during the light irradiation in the above-described (d) is a direction that forms an angle between 30° and 60° with respect to the other surface of either the first substrate or the second substrate.

3. The production method of a liquid crystal element according to claim 1,
wherein the monomer is a monomer that can be polymerized by ultraviolet light.

4. The production method of a liquid crystal element according to claim 1,
wherein the monomer has two or more polymerization sites.

5. The production method of a liquid crystal element according to claim 1,
wherein the monomer is a monomer that contains a chalcone group.

6. The production method of a liquid crystal element according to claim 1,
wherein the first insulating film and the second insulating film are inorganic insulating films formed using silica or titania.

7. The production method of a liquid crystal element according to claim 1,
wherein the first insulating film and the second insulating film are vertical alignment films having an inorganic main chain and side chains, and which have not been subjected to an alignment treatment.

8. The production method of a liquid crystal element according to claim 1,
wherein the above-described (d) includes disposing a mask on the other surface side of the first substrate or the second substrate to partially block light from the liquid crystal layer and applying the light irradiation through the mask, and further applying the light irradiation each time the disposition of the mask is changed.

9. A liquid crystal element comprising:
a first substrate having a first insulating film on one surface side;
a second substrate having a second insulating film on one surface side, the second substrate disposed with a gap provided between the first substrate and the second substrate, with the first insulating film and the second insulating film facing each other;
a liquid crystal layer disposed in the gap between the first substrate and the second substrate;
a first polymer layer having a polymer disposed in a direction inclined relative to the one surface of the first substrate on a surface of the first insulating film facing the liquid crystal layer, and
a second polymer layer having a polymer disposed in a direction inclined relative to the one surface of the second substrate on a surface of the second insulating film facing the liquid crystal layer.

10. The liquid crystal element according to claim 9,
wherein the first insulating film and the second insulating film are inorganic insulating films formed using silica or titania.

11. The liquid crystal element according to claim 9,
wherein the liquid crystal layer is uniformly aligned due to the alignment regulating force exerted by the first polymer layer and/or the second polymer layer.

12. The liquid crystal element according to claim 9,
wherein the polymer of each of the first polymer layer and the second polymer layer is a polymerized monomer having a trans body with a double bond in the center.
